(19) United States
(12) Patent Application Publication
(10) Pub. No.: US 2015/0067178 A1
(43) Pub. Date: Mar. 5, 2015

(54) DATA PROCESSING

(71) Applicant: Metaswitch Networks Ltd, Enfield (GB)

(72) Inventors: Colin TREGENZA DANCER, Enfield (GB); Jon ROWLAND, Enfield (GB); Ed HOLLAND, Enfield (GB); Paul CARTER, Enfield (GB)

(21) Appl. No.: 14/472,275

(22) Filed: Aug. 28, 2014

(30) Foreign Application Priority Data
Aug. 31, 2013 (GB) 1315541.1

(51) Int. Cl. H04L 29/06

(52) U.S. Cl. CPC H04L 65/1069
USPC 709/227

(57) ABSTRACT

Maintaining a list of communication session servers which are currently in an active state and which are currently in a failed state, and which are currently responsible for providing communication services to which subscribers. Receiving a query in relation to a communication session involving a subscriber. In response to the list indicating that a communication session server which is currently responsible for providing communication services to the subscriber currently has an active state, responding to the query with an identifier for the communication session server. In response to the list indicating that the communication session server currently has a failed state, conducting a responsibility transfer operation to transfer responsibility for providing communication services to the subscriber from the communication session server to a different communication session server and responding to the query with an identifier for the different communication session server.

### CROSS-REFERENCE TO RELATED APPLICATIONS

This application claims priority under 35 U.S.C. §119(a) to UK Patent Application No. 1315541.1, filed on Aug. 31, 2013, the entire content of which is hereby incorporated by reference.

### BACKGROUND OF THE INVENTION

1. Field of the Invention

The present disclosure relates to processing data. In particular, but not exclusively, the present disclosure relates to processing data in a telecommunications network comprising a plurality of communication session servers.

2. Description of the Related Technology

A network of communication session servers (for example call processing or telephony servers) provides communication session services (for example Session Initiation Protocol (SIP) based telephony services) to end users (or ‘subscribers’) and allows service providers to manage that service.

In order to scale the service up to large numbers (for example tens of millions) of subscribers the load generated by those subscribers should be spread over the communication session servers so that no individual communication session server ends up overloaded beyond its capacity.

Typically, there will be persistent configuration associated with each subscriber account which should be accessible by the communication session servers in order to provide the correct service to the subscribers.

In designing such a system, a key question that should be considered is: what is the relationship between where the configuration is stored (and hence how it is accessed), and where the communication session processing happens?

There are various known approaches, each with their own pros and cons.

Taking a load balancing model as one example, the load is arbitrarily balanced amongst communication session servers and these communication session servers pull subscriber configuration on-demand from a central database. This model requires that a database lookup between the communication session server and the configuration server happens on the call path which could have a performance or latency impact. Notably, the subscriber's configuration may comprise a reasonable amount of data, so pulling this to the communication session server is not necessarily trivial or quick. With this model, if a communication session server fails, another can pick up the slack as the communication session servers do not keep much state information.

Taking a static model as another example, subscribers are statically assigned to communication session servers and communication sessions (or ‘calls’) are routed to the communication session servers based on a lookup in a location database which returns information about which communication session processing server a particular subscriber is homed on. This model allows the communication session processing servers to access subscriber configuration locally (e.g. from random access memory (RAM)) and so is relatively fast. However, this model is exposed to failure of a communication session server; any subscribers whose configuration is statically assigned to a failed communication session server will lose service while that communication session server is unavailable.

Taking a hybrid model as a further example, for example as used in an Internet Protocol Multimedia Subsystem (IMS) framework to allocate subscribers to serving call Session control functions (S-CSCFs). In this model, subscribers are temporarily assigned to communication session servers, but the configuration still lives centrally. Such a hybrid model suffers to some extent from the issues outlined above for the load balancing model.

It would therefore be desirable to provide improved way to process data in a telecommunications network comprising a plurality of communication session servers.

### SUMMARY

According to embodiments of the present disclosure, there is a method of processing data in a telecommunications network, the method comprising: maintaining a list of which communication session servers in a plurality of communication session servers are currently in an active state and which are currently in a failed state, and which communication session servers in the plurality are currently responsible for providing communication services to which subscribers, wherein each communication session server in the plurality is responsible for providing communication services to one or more subscribers; receiving a query in relation to a communication session involving a given subscriber, the query querying which communication session server in the plurality is currently responsible for providing communication services to the given subscriber; in response to the list indicating that a first communication session server in the plurality which is currently responsible for providing communication services to the given subscriber currently has an active state, responding to the query with an identifier for the first communication session server; and in response to the list indicating that the first communication session server in the plurality which is currently responsible for providing communication services to the given subscriber currently has a failed state, conducting a responsibility transfer operation to transfer responsibility for providing communication services to the given subscriber from the first communication session server to a second, different communication session server in the plurality and responding to the query with an identifier for the second communication session server.

According to embodiments of the present disclosure, there is a non-transitory computer-readable storage medium comprising computer-executable instructions which, when executed by a processor, cause a computing device to perform a method of processing data in a telecommunications network, the method comprising: maintaining a list of which communication session servers in a plurality of communication session servers are currently in an active state and which are currently in a failed state, and which communication session servers in the plurality are currently responsible for providing communication services to which subscribers, wherein each communication session server in the plurality is responsible for providing communication services to one or more subscribers; receiving a query in relation to a communication session involving a given subscriber, the query querying which communication session server in the plurality is currently responsible for providing communication services to the given subscriber; in response to the list indicating that a first communication session server in the plurality which is currently responsible for providing communication services to the given subscriber currently has an active state, responding to the query with an identifier for the first communication session server; and in response to the list indicating that the first communication session server in the plurality which is currently responsible for providing communication services to the given subscriber currently has a failed state, conducting a responsibility transfer operation to transfer responsibility for providing communication services to the given subscriber from the first communication session server to a second, different communication session server in the plurality and responding to the query with an identifier for the second communication session server.

According to embodiments of the present disclosure, there is a system for use in processing data in a telecommunications network, the system comprising: at least one memory including computer program code; and at least one processor in data communication with the at least one memory, wherein the at least one processor is configured to: maintain a list of which communication session servers in a plurality of communication session servers are currently in an active state and which are currently in a failed state, and which communication session servers in the plurality are currently responsible for providing communication services to which subscribers, wherein each communication session server in the plurality is responsible for providing communication services to one or more subscribers; receive a query in relation to a communication session involving a given subscriber, the query querying which communication session server in the plurality is currently responsible for providing communication services to the given subscriber; in response to the list indicating that a first communication session server in the plurality which is currently responsible for providing communication services to the given subscriber currently has an active state, respond to the query with an identifier for the first communication session server; and in response to the list indicating that the first communication session server in the plurality which is currently responsible for providing communication services to the given subscriber currently has a failed state, conduct a responsibility transfer operation to transfer responsibility for providing communication services to the given subscriber from the first communication session server to a second, different communication session server in the plurality and respond to the query with an identifier for the second communication session server.

Further features of embodiments will become apparent from the following description of preferred embodiments of the present disclosure, given by way of example only, which is made with reference to the accompanying drawings.

### BRIEF DESCRIPTION OF THE DRAWINGS

FIG. 1 shows a diagram of a telecommunications network according to one or more embodiments of the present disclosure;

FIG. 2 shows a diagram according to one or more embodiments of the present disclosure; and

FIG. 3 shows a flow diagram according to one or more embodiments of the present disclosure.

### DETAILED DESCRIPTION OF CERTAIN INVENTIVE EMBODIMENTS

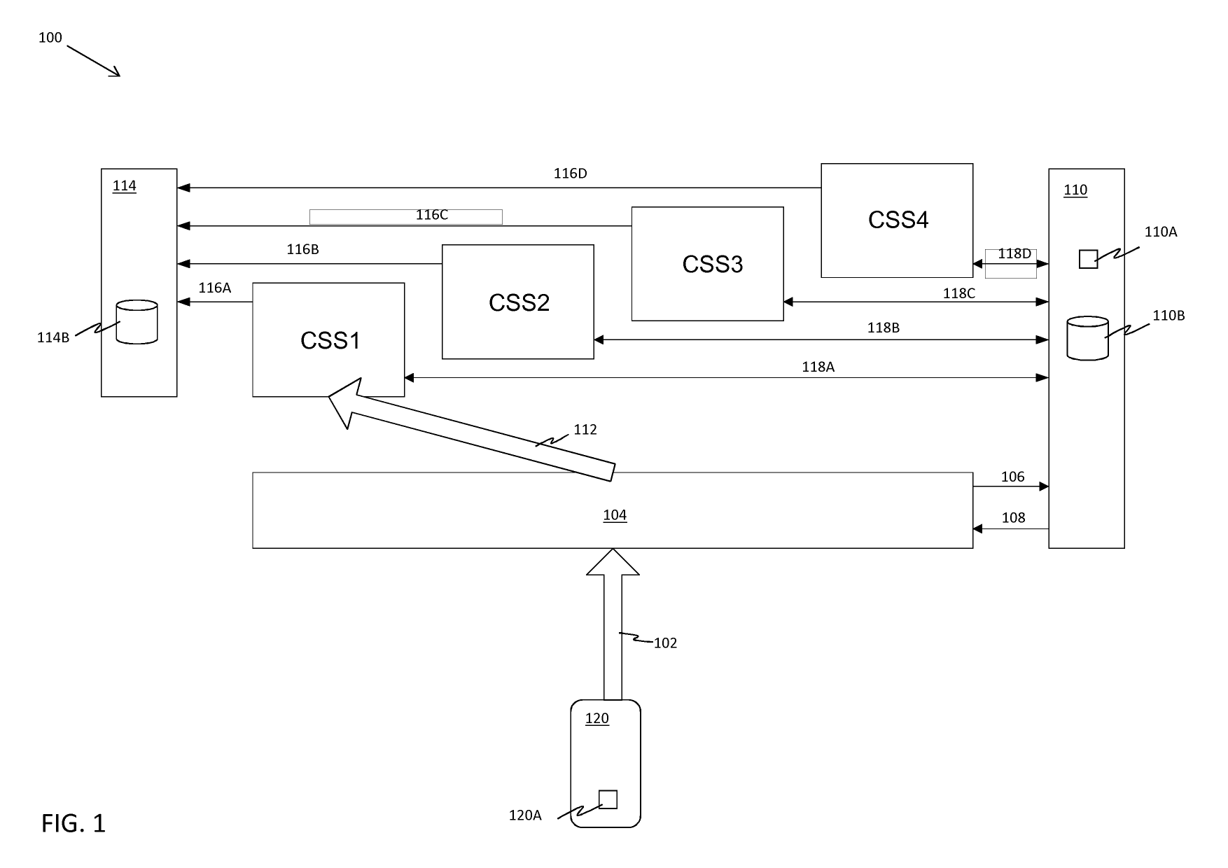

FIG. 1 shows a diagram of a telecommunications network 100 according to embodiments.

Telecommunications network 100 comprises a plurality of communication session servers, CSS1, CSS2, CSS3, CSS4, each communication session server in the plurality being responsible for providing communication services to one or more subscribers. In embodiments, each communication session server in the plurality of network nodes comprises a processing system (not shown), for example comprising one or more processors and/or memories, for carrying out data processing tasks.

Telecommunications network 100 also comprises a network routing node 104, which is responsible for routing data relating to communication sessions conducted in telecommunications network 100. Network routing node 104 may also perform tasks other than routing, for example conducting registration and/or authentication procedures, etc.

Any of communication session servers CSS1, CSS2, CSS3, CSS4 and network routing node 104 may for example comprise a node performing the functions of one or more routers, servers, softswitches, CSCFs, SIP Routers, SIP Registrars, SIP Service Nodes, SIP Proxies, etc.

Telecommunications network 100 also comprises a location database and failure manager node 110 which is responsible for providing communication session server location services and communication session server failure management services according to embodiments. Location database and failure manager node 110 comprises a processing system 110A (for example comprising one or more processors and/or memories) and a database 110B for performing data processing and/or data storage tasks according to embodiments.

User device 120 is configured to conduct telephony sessions via telecommunications network 100. User device 120 comprises a processing system 120A, for example comprising memory and/or one or more processors, configurable to carry out various data processing and data storage tasks. User device 120 could comprise any device capable of conducting communication (or ‘media’) sessions such as voice or video calls with one or more other user devices (not shown) or network nodes. User device 120 could for example comprise a personal computer (PC), a mobile (or ‘cellular’) telephone, a voice over internet protocol (VoIP) telephone, a session initiation protocol (SIP) device, tablet, phablet, etc.

User device 120 communicates in telecommunications network 100 via network routing node 104. The communication link between user device 120 and network routing node 104 may further comprise one or more intermediate entities, such as wireless access points, routing devices, etc. Network routing node 104 may be further responsible for interfacing between telecommunications network 100 and one or more further user devices (not shown).

Telecommunications network 100 also comprises a subscriber configuration data node 114 responsible for storing (or ‘backing-up’) subscriber configuration data for subscribers. Communication services are provided by communication session servers CSS1, CSS2, CSS3, CSS4 in the plurality to subscribers according to subscriber configuration data associated with (or ‘provisioned for’) respective subscribers.

As shown by items 116A, 116B, 116C and 116D, communication session servers CSS1, CSS2, CSS3 and CSS4 respectively, provide a copy of subscriber configuration data for each of the subscribers they are responsible for providing communication services to to subscriber configuration data node 114. In embodiments, the subscriber configuration data provided to subscriber configuration data node 114 by communication session servers CSS1, CSS2, CSS3, CSS4 is stored in database 114B.

Embodiments comprise measures, including methods, apparatus, computer software and computer program products, for processing data in a telecommunications network, the network comprising a plurality of communication session servers, each communication session server in the plurality being responsible for providing communication services to one or more subscribers.

A list of which communication session servers in the plurality are currently in an active state and which are currently in a failed state, and which communication session servers in the plurality are currently responsible for providing communication services to which subscribers is maintained by location database and failure manager node 110. In embodiments, the maintained list is stored in database 110B.

In embodiments, location database and failure manager node 110 receives communication session server health data from communication session servers in the plurality indicating which communication session servers in the plurality are currently in an active state, as shown by items 118A, 118B, 118C, and 118D for communication session servers CSS1, CSS2, CSS3, CSS4 respectively. In embodiments, the list is maintained by location database and failure manager node 110 at least in part on the basis of the received communication session server health data. In embodiments, the received communication session server health data is received via a heartbeat mechanism.

In embodiments, location database and failure manager node 110 receives current subscriber responsibility data from one or more communication session servers in the plurality indicating which subscribers a respective communication session server is currently responsible for providing communication services to. In embodiments, the list is maintained at least in part on the basis of the received current subscriber responsibility data.

In embodiments, a user of user device 120 initiates setup of a communication session with a subscriber having an associated subscriber device (not shown) they wish to communicate with using user device 120, for example by dialing a telephone number for the subscriber. The subscriber is provided with communication services according to embodiments The initiation results in a request message being transmitted from user device 120 to network routing node 104 (possibly via one or more other entities), as shown by item 102. Upon receipt of the communication session setup message, network routing node 104 transmits a query in relation to the communication session involving the given subscriber to location database and failure manager node 110, as shown by item 106. The query of item 106 queries which communication session server in the plurality is currently responsible for providing communication services to the given subscriber.

The query of item 106 is received by location database and failure manager node 110 and, in response to the list (maintained by location database and failure manager node 110) indicating that a first communication session server CSS1 in the plurality which is currently responsible for providing communication services to the given subscriber currently has an active state, location database and failure manager node 110 responds to the query with an identifier for the first communication session server CSS1 in item 108. The identifier may comprise a network address for the first communication session server CSS1, for example an Internet Protocol (IP) address.

Upon receipt of the response of item 108, network routing node 104 knows which communication session server (in this case communication session server CSS1) is currently responsible for providing communication services to the given subscriber and how to contact that communication session server and forwards a request message to communication session server CSS1 accordingly, as shown by item 104. Communication session server CSS1 then processes the request message in relation to the communication session according to subscriber configuration data it has stored locally for the given subscriber.

In the embodiments of FIG. 1, four communication session servers provide communication services to a group of subscribers; in practice, communication services may be provided by more or less than four communication session servers.

In embodiments, each communication session server is provisioned with subscriber configuration data for a non-overlapping subset of the subscribers. In embodiments, each communication session server sends a copy of its subscriber configuration to central subscriber configuration data node 114 (or ‘configuration backup store’). In embodiments, the location database and failure management functions are implemented as a single central network element and hence can share state information. In some embodiments, the location database and failure management functions are implemented by a single logical element, but in some embodiments may comprise multiple nodes for redundancy purposes.

In embodiments, each communication session server has a Stream Control Transmission Protocol (SCTP)-based IP connection to location database and failure management node 110 (SCTP may include heartbeating functionality, so the connection will fail in a timely manner if the communication session server fails). In embodiments, location database and failure manager node 110, uses the health of a given connection to determine if a given communication session server is active. In other embodiments, each communication session server has a Transmission Control Protocol (TCP) or User Datagram Protocol (UDP) connection to location database and failure management node 110 which may be used to enable heartbeat functionality. In alternative embodiments, a mixture of SCTP, TCP UDP and/or other suitable connections may be employed.

In embodiments, a collection or group of communication session servers may be referred to as a site. In embodiments, each communication session server populates an entry into the central location database at location database and failure manager node 110 to indicate which subscribers are homed on that communication session server; this information may also include information about a subscriber's preferred home site. A subscriber may also have a preferred communication session server via which communication services should be provided to that subscriber if possible (a subscriber's preferred communication session server will generally be comprised within that subscriber's preferred home site).

In embodiments, each communication session server also reports its available capacity to location database and failure manager node 110 over the same interface. Available capacity can be re-reported by a communication session server if the available capacity changes, for example if new subscribers are provisioned on or removed from the server by management action.

In embodiments, a network routing node 104 (or ‘router component’), for example a SIP Router, is configured ‘in front’ of the communication session servers and when a request (for example a SIP request) arrives from the network (for example from an end user's phone) it sends a query to the location database of location database and failure manager node 110, which responds with information identifying which communication session server is currently responsible for providing communication services (or ‘owns’) the subscriber.

Network routing node 104 then forwards the request on to the correct communication session server. In the example embodiments depicted in FIG. 1, communication session server CSS1 currently owns the relevant subscriber.

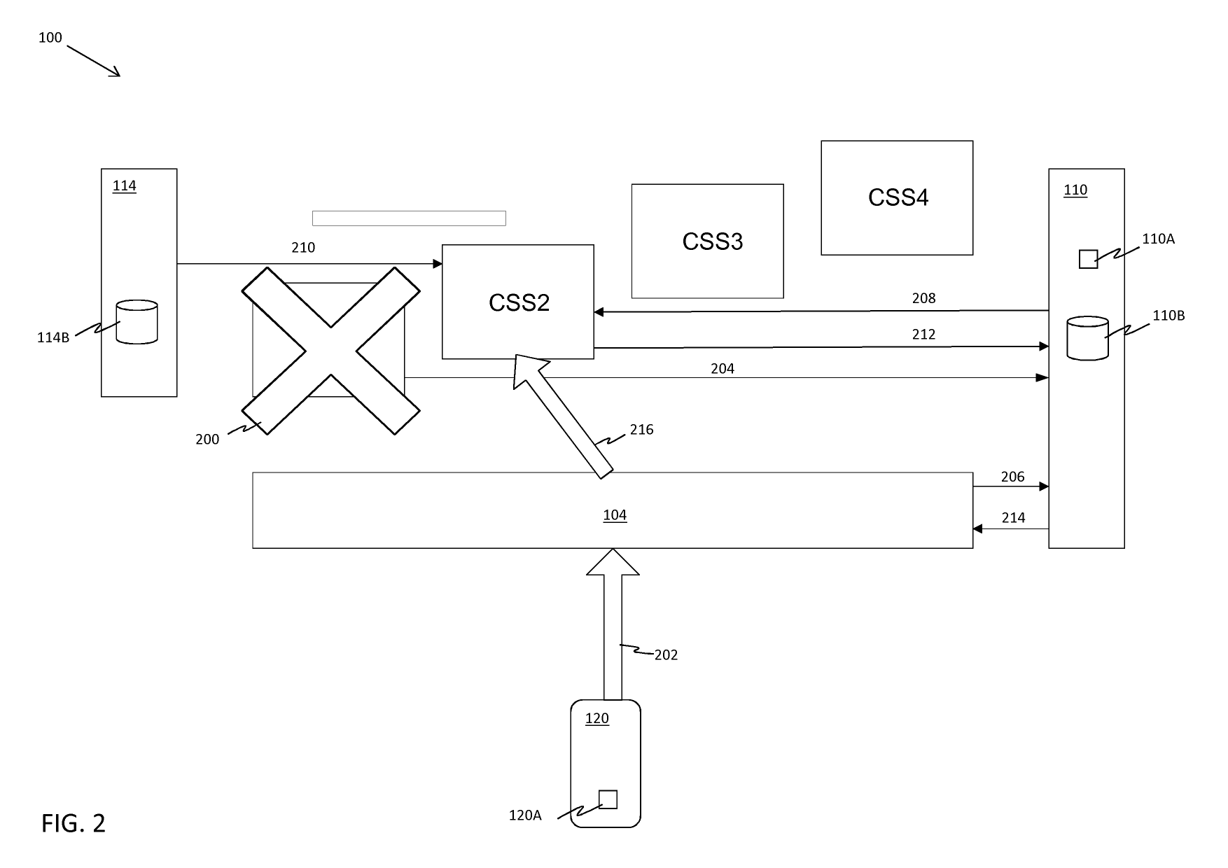

FIG. 2 shows a diagram of a telecommunications network 100 according to embodiments. Many of the elements/items of FIG. 1 are also featured in FIG. 1. In FIG. 2, however, communication session server CSS1 has failed, i.e. has entered a failed state, as shown by item 200. When communication session server CSS1 fails, location database and failure manager node 110 learns of such failure as shown by item 204, for example by location database and failure manager node 110 not receiving an expected heartbeat signal from communication session server CSS1 in a timely fashion. Location database and failure manager node 110 therefore updates the maintained list to indicate that communication session server CSS1 is currently in a failed state. Location database and failure manager node 110 does not carry out any responsibility transfer operations for subscribers from communication session server CSS1 to one or more different communication session servers at this stage.

In embodiments, a user of user device 120 initiates setup of a communication session with a subscriber having an associated subscriber device (not shown) they wish to communicate with using user device 120. The initiation results in a request message being transmitted from user device 120 to network routing node 104, as shown by item 202. Upon receipt of the communication session setup message, network routing node 104 transmits a query in relation to the communication session involving the given subscriber to location database and failure manager node 110, as shown by item 206. The query of item 106 queries which communication session server in the plurality is currently responsible for providing communication services to the given subscriber.

The query of item 106 is received by location database and failure manager node 110 and in response to the list indicating that the first communication session server CSS1 in the plurality which is currently responsible for providing communication services to the given subscriber currently has a failed state, location database and failure manager node 110 conducts a responsibility transfer operation to transfer responsibility for providing communication services to the given subscriber from the first communication session server CSS1 to a second, different communication session server in the plurality. In this case, location database and failure manager node 110 chooses to transfer responsibility for providing communication services to the given subscriber to CSS2, i.e. the given subscriber is transferred to CSS2 instead of CSS1. A responsibility transfer operation can also be referred to as a re-homing operation or a re-instantiation operation.

In embodiments, conducting the responsibility transfer operation comprises location database and failure manager node 110 instructing (as shown by item 208) the second communication session server CSS2 to retrieve (as shown by item 210) subscriber configuration data for the given subscriber from subscriber configuration data node 114 and store the retrieved subscriber configuration data for the given subscriber locally for use in providing communication services to the given subscriber. Once the second communication session server CSS2 has retrieved the subscriber configuration data for the given subscriber from subscriber configuration data node 114, communication session server CSS2 is ready to start providing communication services to the given subscriber when required, i.e. communication session server CSS2 is now responsible for providing communication services to the given subscriber; communication session server CSS2 informs location database and failure manager node 110 of such, as shown by item 212, and location database and failure manager node 110 updates the maintained list accordingly.

Location database and failure management node 110 now responds to the query from network routing node 104 with an identifier for the second communication session server CSS2, as shown by item 214.

Upon receipt of the response of item 214, network routing node 104 knows which communication session server (in this case communication session server CSS2) is currently responsible for providing communication services to the given subscriber and how to contact that communication session server and forwards a request message to communication session server CSS2 accordingly, as shown by item 216. Communication session server CSS2 then processes the request message in relation to the communication session according to subscriber configuration data it has stored locally for the given subscriber. The given subscriber's service thus continues uninterrupted after only a small one-off delay

In the embodiments of FIG. 2 described above, communication session server CSS1 fails, i.e. enters a failed state (as shown by item 200). The failure could for example be due to an actual failure of the hardware and/or software on CSS1, but alternatively or in addition could also be due to a network event that means that communication session server CSS1 is disconnected from all or part of the surrounding network. Either way, the connection to location database and failure management node 110 thus goes down, which means that location database and failure management node 110 becomes aware of the inactive state of communication session server CSS1.

In embodiments, failed servers can leave subscribers homed in their non-preferred site. Embodiments therefore provide a mechanism to move subscribers back to their preferred site once any failures have been recovered. This may for example be achieved by a manual triggering of a function which forces a rehoming operation to occur.

In embodiments, in response to the communication session server health data received by location database and failure manager node 110 indicating that first communication session server CSS1 has returned to an active state, location database and failure manager node 110 conducts a further responsibility transfer operation to transfer responsibility for providing communication services to the given subscriber from second communication session server CSS2 back to first communication session server CSS1. In embodiments, first communication session server CSS1 comprises a preferred home communication session server for the given subscriber. In embodiments, the first preferred home communication session server for the given subscriber is comprised in a preferred site for the given subscriber.

In some embodiments, conducting the further responsibility transfer operation comprises location database and failure manager node 110 instructing first communication session server CSS1 (which has returned to an active state after a failure) to retrieve subscriber configuration data for the given subscriber from subscriber configuration data node 114 and store the retrieved subscriber configuration data for the given subscriber locally for use in providing communication services to the given subscriber. In other embodiments, first communication session server CSS1 maintains its local subscriber configuration, in which case there is no requirement for first communication session server CSS1 to retrieve such configuration data from subscriber configuration data node 114 when conducting the further responsibility transfer operation.

In embodiments, conducting the further responsibility transfer operation comprises location database and failure manager node 110 instructing second communication session server CSS2 to delete locally stored subscriber configuration data for the given subscriber. Therefore, in embodiments, when a previously failed communication session server recovers, it may still contain configuration for a subscriber that has since been moved to a new communication session server. When this happens, embodiments involve deleting the unwanted configuration from the communication session server which the subscriber was rehomed on. Embodiments may involve choosing a preferred location to keep and deleting unwanted locations based on a range of inputs.

In embodiments, the current subscriber responsibility data received by location database and failure manager node 110 contains at least one indication as to which communication session server in the plurality is a preferred home communication session server for providing communication session services to at least one subscriber.

In embodiments, the current subscriber responsibility data received by location database and failure manager node 110 contains one or more priority indications as to which communication session servers in the plurality are preferred over other communication session servers in the plurality for providing communication session services to at least one subscriber. Embodiments therefore allow control over how subscribers are rehomed. For example, rather than subscribers having a single preferred home site, they could have a prioritized list of sites.

In embodiments, at a first point in time, the maintained list indicates that a particular communication session server in the plurality has a failed state, and at a second, subsequent point in time, the maintained list indicates that the particular communication session server has returned to an active state. In such embodiments, during the period between the first point in time and the second point in time, if no query is received by location database and failure manager node 110 in relation to a communication session involving any of the subscribers for which the particular communication session server is responsible for providing communication session services to, then no responsibility transfer operations are conducted by location database and failure manager node 110 to transfer responsibility for providing communication services to any of the subscribers for which the particular communication session server is responsible for providing communication session services to away from the particular communication session server.

Embodiments comprise location database and failure manager node 110 receiving communication session server available capacity data from communication session servers in the plurality indicating the current available capacity of respective communication session servers in the plurality for providing communication services to subscribers. The received communication session server available capacity data may for example indicate that responsibility for one or more additional or one or fewer subscribers have been provisioned on at least one communication session server in the plurality.

In embodiments, conducting the responsibility transfer operation comprises selecting second communication session server CSS2 from the plurality at least on the basis of the received communication session server available capacity data.

In embodiments, conducting the responsibility transfer operation comprises preferentially selecting the second communication session server from the plurality in order to balance the processing load for providing communication session services to subscribers between one or more communication session servers in the plurality.

In embodiments, conducting the responsibility transfer operation comprises preferentially selecting the second communication session server from the plurality on the basis that the query was received from a location associated with the second communication session server. In some such embodiments, the association comprises a proximate geographical location association.

In embodiments, conducting the responsibility transfer operation comprises preferentially selecting the second communication session server from the plurality on the basis of a hash-based selection. In some such embodiments, an identifier associated with the given subscriber is used as an input to the hash-based selection.

In embodiments, the plurality comprises at least a first group of communication session servers and a second subset of communication session servers, and conducting the responsibility transfer operation comprises preferentially selecting second communication session server CSS2 from the first group instead of the second group. The first group may for example be associated with a first geographical location area and the second group may for example be associated with a second, different geographical location area. In embodiments, a preferred home communication session server for the given subscriber is comprised within the first group. In embodiments the query of item 106 of FIG. 1 and/or item 206 of FIG. 2 is received from a location associated with the first group.

Embodiments involve dealing with dynamically changing load requirements. For example, in periods of low communication session traffic, a smaller number of communication session servers in the plurality may be adequate to handle the communication session processing load. Embodiments therefore comprise one or more communication session servers in the plurality being manually or automatically deactivated (for example to save costs) and their subscribers are provided communications services by the remaining communication session servers in the plurality.

In embodiments, in response to communication service activity via communication session servers in the plurality falling below a predetermined activity threshold, location database and failure manager node 110 initiates a communication session server deactivation procedure to deactivate one or more communication session servers in the plurality from providing communication services to subscribers. In embodiments, initiating the communication session server deactivation procedure comprises conducting one or more responsibility transfer operations to transfer responsibility for providing communication services to subscribers away from the one or more deactivated communication session servers to one or more other communication session servers in the plurality.

In embodiments, in response to communication service activity via communication session servers in the plurality rising above the predetermined activity threshold, location database and failure manager node 110 initiates a communication session server re-activation procedure to re-activate the one or more deactivated communication session servers in the plurality to provide communication services to subscribers. In embodiments, initiating the communication session server re-activation procedure comprises conducting one or more responsibility transfer operations to transfer responsibility for providing communication services to subscribers back to the one or more re-activated communication session servers.

Embodiments use some features of a static model with several key improvements. In embodiments, subscribers are statically assigned to communication session servers when they are provisioned. Subscriber configuration data is effectively mastered on the communication session servers, but it is also “backed-up” into a central configuration store on subscriber configuration data node 114. Embodiments therefore reap the benefits of the high performance of the static model in the mainline. A network node/component in the form of location database and failure manager node 110 acts as a failure manager and monitors the health of the communication session servers. If a communication session server fails then the failure manager will detect this and has the ability to trigger a just-in-time (initialized by a lookup in the location database returning a failed server as a result when a call is processed) re-instantiation of the subscriber's configuration onto a different communication session server in the plurality.

Over time, a subscriber's configuration may end up on multiple communication session servers, for example if a subscriber's configuration is moved between communication session servers multiple times and those communication session servers fail. Embodiments involve pulling the most up-to-date version of the subscriber configuration (taking into account any recent management operations) from the subscriber configuration data backup database. Management operations may for example involve a service provider making one or more alterations to how one or more of the communication session servers and/or location database and failure manager node 110 operate in relation to provision of communication services. Management operations may involve change of subscriber configuration data associated with one or more subscribers. Management operations may themselves trigger responsibility transfer operations.

Embodiments comprise selecting which new communication session server to use at a per-subscriber-scope. Once this has happened, embodiments return to using a static model and its benefits, but with failure case issues having been solved. Because the re-instantiation (i.e. rehoming of a subscriber to a different communication session server) is carried out “just-in-time”, the rate at which this operation needs to be supported is naturally limited by the rate of events arriving from the network (e.g. new SIP calls). Embodiments therefore have a benefit in overall performance over a scheme where the failure of the communication session server itself triggers a bulk operation to rehome subscribers.

In embodiments, location database and failure manager node 110 selects a new communication session server on which to instantiate the subscriber configuration for the given subscriber. In embodiments, location database and failure manager node 110 is itself geographically distributed for redundancy purpose. Having a resilience scheme as per embodiments provides geographic redundancy; a whole physical site containing some portion of the communication session servers in the plurality may be destroyed and service continuity should be enabled. In embodiments, the communication session server selection algorithm includes two levels of logic, one at the level of “site selection” and one to select a particular communication session server within a given site. Here “site” may for example a grouping of servers, which may correspond to geographic co-location.

In embodiments, location database and failure manager node 110 is provisioned with information about which communication session servers are in which sites. In alternative embodiments, information about which communication session servers are in which sites is provided to location database and failure manager node 110 by one or more of the communication session servers in the plurality.

In embodiments, subscribers are provisioned with a preferred home site which may correspond to the physical location where processing for that subscriber should preferably occur (for example based on physical network proximity to the subscriber's subscriber device(s)). This information is then made available to location database and failure manager node 110. In embodiments, communication session servers report their available spare capacity to location database and failure manager node 110.

In embodiments, during a responsibility transfer operation, location database and failure manager node 110 selects a communication session server from the plurality to transfer responsibility for providing communication services to according to one or more of the following processes:

A query to look up the location (owning communication session server) of a subscriber arrives at location database and failure manager node 110. Location database and failure manager node 110 determines that the location is currently inactive. Location database location database and failure manager node 110 selects a site in which to re-instantiate the subscriber as per the following:

If there is only a single site, that site is the only option.

If there are multiple sites:

1. The preferred home site of the subscriber is chosen if it has spare capacity.

2. Otherwise the site in which the request message that triggered the query arrived is chosen (the subscriber's user device is likely to have network access to this site), if it has spare capacity.

3. Otherwise, the site with the highest available capacity is chosen.

If no site has available capacity the query (and hence setup of the communication session) is failed.

Other embodiments may employ different ways to select a site.

Once a site has been chosen, a communication session server can be chosen within that site according to one or more of the following processes:

Communication session servers report their spare capacity to location database and failure management node 110.

New instantiations of subscribers within a site are load balanced amongst communication session servers in the plurality in a weighted fashion based on their currently reported available capacity. This spreads the processing load so that no single communication session server is overloaded with new instantiation requests, but enables the least loaded communication session server to receive a higher proportion of instantiations, thus tending to bring all the communication session servers towards having the same spare capacity available for the best spread of load handling.

In embodiments, once a communication session server has been selected, location database and failure management node 110 sends it a request to pull the relevant copy of the given subscriber's configuration from the configuration backup store 114 and is able to start providing service to that subscriber when a communication session involving the subscriber is subsequently initiated.

The request (for example a SIP INVITE message) that kicked-off the process is then routed to the selected communication session server for processing (for example to set up a call to/from the subscriber).

Other embodiments may employ different ways to select a communication session server.

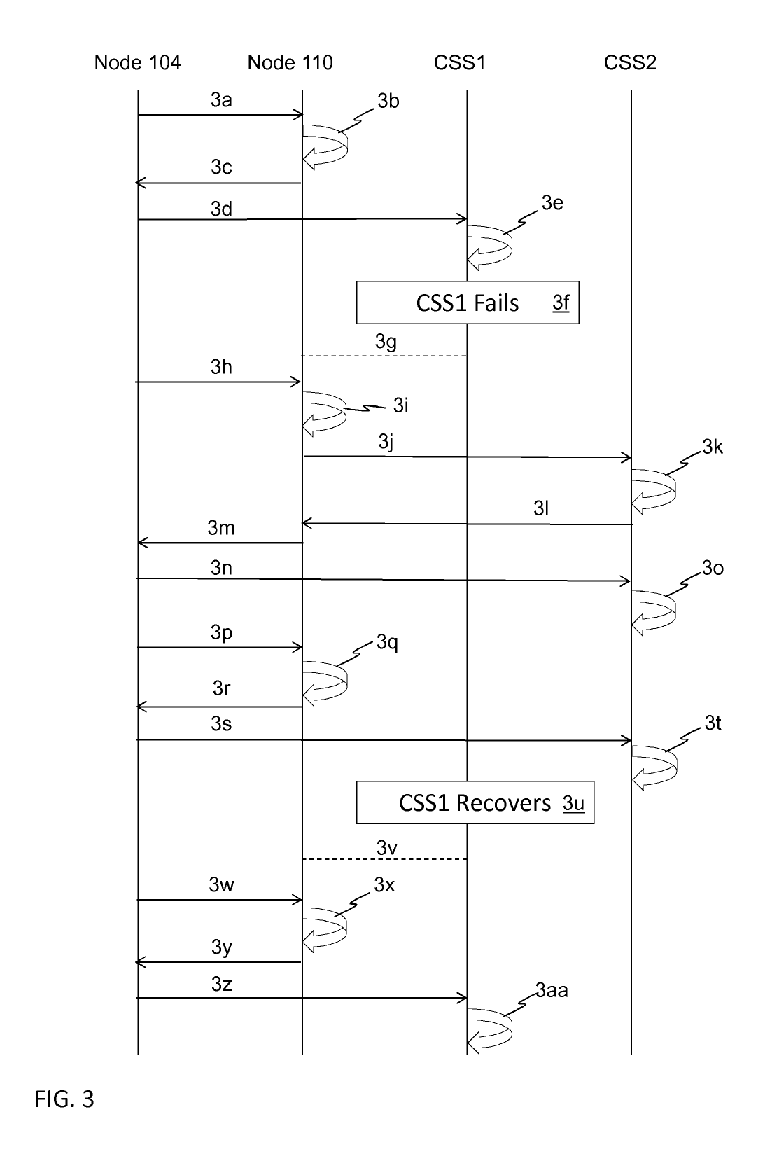

FIG. 3 shows a flow diagram according to embodiments. FIG. 3 shows a configuration where two subscribers are initially homed on communication session server CSS1.

In step 3a, a first query in relation to setup of a first communication session involving the first subscriber arrives at location database and failure manager node 110 from network routing node 104. The first query queries which communication session server in the plurality is currently responsible for providing communication services to the first subscriber. Location database and failure manager node 110 performs a lookup in the maintained list stored in location database 110B in step 3b which indicates that communication session server CSS1 in the plurality is currently responsible for providing communication services to the first subscriber. The maintained list indicates that communication session server CSS1 has an active state, so location database and failure manager node 110 responds to the query with an identifier for communication session server CSS1 in step 3c. Network routing node 104 then contacts communication session server CSS1 in relation to setup of the first communication session in step 3d and communication session server CSS1 processes setup of the first communication session for the first subscriber accordingly in step 3e.

Communication session server CSS1 now fails in step 3f, which fact is detected by location database and failure manager node 110 sometime subsequently in step 3g. Location database and failure manager node 110 updates the maintained list stored in location database 110B accordingly to indicate that communication session server CSS1 currently has a failed state. Location database and failure manager node 110 takes no further action at this time.

In step 3h, a second query in relation to setup of a second communication session involving the first subscriber arrives at location database and failure manager node 110 from network routing node 104. The second query queries which communication session server in the plurality is currently responsible for providing communication services to the first subscriber. Location database and failure manager node 110 performs a lookup in the maintained list stored in location database 110B in step 3i which indicates that communication session server CSS1 in the plurality is currently responsible for providing communication services to the first subscriber. However, the maintained list also indicates that communication session server CSS1 currently has a failed state. Location database and failure manager node 110 thus conducts a responsibility transfer operation to transfer responsibility for providing communication services to the first subscriber from communication session server CSS1 to a second, different communication session server in the plurality, in this case communication session server CSS2.

Conducting the responsibility transfer operation involves location database and failure manager node 110 instructing, in step 3j, communication session server CSS2 to retrieve subscriber configuration data for the first subscriber from subscriber configuration data node 114 and store the retrieved subscriber configuration data for the first subscriber locally for use in providing communication services to the first subscriber, which communication session server CSS2 does in step 3k. Once communication session server CSS2 has retrieved the subscriber configuration data for the first subscriber from subscriber configuration data node 114, communication session server CSS2 is ready to start providing communication services to the given subscriber when required, i.e. communication session server CSS2 is now responsible for providing communication services to the first subscriber and informs location database and failure manager node 110 of such in step 3l. Location database and failure manager node 110 updates the maintained list accordingly and responds to the second query from network routing node 104 with an identifier for communication session server CSS2 in step 3m. Network routing node 104 then contacts communication session server CSS2 in relation to setup of the second communication session in step 3n and communication session server CSS2 processes setup of the second communication session for the first subscriber accordingly in step 3o.

In step 3p, a third query in relation to setup of a third communication session involving the first subscriber arrives at location database and failure manager node 110 from network routing node 104. The third query queries which communication session server in the plurality is currently responsible for providing communication services to the first subscriber. Location database and failure manager node 110 performs a lookup in the maintained list stored in location database 110B in step 3q which indicates that communication session server CSS2 in the plurality is currently responsible for providing communication services to the first subscriber. The maintained list indicates that communication session server CSS2 has an active state, so location database and failure manager node 110 responds to the query with an identifier for communication session server CSS2 in step 3r. Network routing node 104 then contacts communication session server CSS2 in relation to setup of the third communication session in step 3s and communication session server CSS2 processes setup of the third communication session for the first subscriber accordingly in step 3t.

Communication session server CSS1 now recovers in step 3u, which fact is detected by location database and failure manager node 110 sometime subsequently in step 3v. Location database and failure manager node 110 updates the maintained list stored in location database 110B accordingly to indicate that communication session server CSS1 currently has an active state.

In step 3w, a fourth query in relation to setup of a fourth communication session involving the second subscriber arrives at location database and failure manager node 110 from network routing node 104. The fourth query queries which communication session server in the plurality is currently responsible for providing communication services to the second subscriber. Location database and failure manager node 110 performs a lookup in the maintained list stored in location database 110B in step 3x which indicates that communication session server CSS1 in the plurality is currently responsible for providing communication services to the second subscriber. The maintained list indicates that communication session server CSS1 has an active state, so location database and failure manager node 110 responds to the query with an identifier for communication session server CSS1 in step 3y. Network routing node 104 then contacts communication session server CSS1 in relation to setup of the fourth communication session in step 3z and communication session server CSS1 processes setup of the fourth communication session for the second subscriber accordingly in step 3aa.

To summarize the events in embodiments depicted in FIG. 3, three communication session setup requests arrive for the first subscriber, with a failure of the owning communication session server CSS1 before the second request triggering a rehoming when the second request arrives. A communication session request for the second subscriber after original communication session server CSS1 has recovered shows that the second subscriber is never moved off communication session server CSS1, illustrating that the location database and failure manager node 110 only takes “just-in-time” action; if no event arrives for a subscriber during a failure, no rehoming takes place.

In embodiments, the term ‘lookup’ is used to refer to a query to a database that returns the location (i.e. owning communication session server) for a subscriber which is fast enough that it can happen on the communication session setup path without adding undue delay to the communication session setup. Typically, such a lookup will receive a response within a few milliseconds and will employ a high performance database with in-memory data connected over a low-latency network.

Some embodiments do not distinguish between different “sites” (as per communication session server selection embodiments described above). In embodiments, the logical setup is unchanged for multiple sites, although central configuration store and location database/failure manager components may be implemented as network-wide single logical entities with physical server(s) in each geographic site and replication of all state between the underlying physical servers, so that each instance can provide the same information and implement the appropriate processes.

In multisite embodiments, communications session servers in the plurality need only connect to the location database and failure manager node 110 in their local site and each location database and failure manager node is responsible for replicating information for its local communication session servers to location database and failure manager node instances in other sites, and for proxying instantiation requests to the location database and failure manager node in the target site.

Embodiments involve mastering the full subscriber configuration on the communication session server handling the communication session processing, which provides improvements in performance and latency.

Embodiments have the capability to scale higher for management operations because the management load is spread amongst the servers mastering the data, rather than being bottle-necked in a central subscriber configuration database (for example as with the Home Subscriber Server (HSS) in IMS).

Embodiments involve real end-users for whom the network is providing a critical service where that service is both personalized and personalizable by that end user, and these service settings are stored as configuration in the network. Embodiments do not involve accessing generic data, or merely routing arbitrary packets. In the event of a failure, embodiments provide service again in a timely manner and crucially with the same personal service settings as the end user desires and expects.

Embodiments do not require reconfiguration of adjacent network devices to cope with the failures which means that embodiments are more efficient and more widely applicable.

Embodiments can be referred to as “active-active”, i.e. all (or nearly all) communication session servers in a plurality are running at a given time. Embodiments are therefore able to make use of spare capacity on individual communication session servers to move over configuration from failed communication session servers. In embodiments, there is no requirement for standby communication session servers. In embodiments, it is known which communication session servers are operational and working before using them to recover from a failure.

Embodiments involve failure recovery which is “just in time”; when a communication session server failure is discovered, no immediate switching over of a whole communication session server's worth of configuration and the associated processing to a new replacement communication session server is carried out. Instead, recovery is at a per-subscriber level where network events are used to trigger rehoming of a single subscriber record onto a new communication session server. Such “just in time” rehoming provides significant performance gain in that there is no bulk rehoming operation at the point of the communication session server failure. In embodiments, any rehoming processing is naturally spread out over a period of time which is less disruptive to the network as a whole. If a failed communication session server recovers before a particular subscriber tries to use the system, then there will be no need to have moved anything which saves on resources and time.

The above embodiments are to be understood as illustrative examples of the present disclosure. Further embodiments of the present disclosure are envisaged.

In embodiments described above, the location database and failure management function are co-located at location database and failure manager node 110. In alternative embodiments, the location database and failure management function are located at separate entities/nodes which may be situated at different logical and/or physical locations in the network.

Embodiments described above involve receipt of a query at location database and failure management node 110 in relation to a communication session involving a given subscriber. Embodiments can be applied in relation to establishment (i.e. during the setup phase) of a communication session and/or in relation to a communication session which already exists (i.e. after the setup phase has been completed).

Embodiments described above involve communication sessions directed towards a subscriber who is provided communication services by communication session servers according to embodiments, i.e. the subscriber is the calling party. Embodiments can also be applied to communications session originating from a subscriber who is provided communication services by communication session servers according to embodiments, i.e. the subscriber is the called party.

The location database and failure management node 110 of embodiments can be applied to service other types of network node, i.e. not just communication session servers. Embodiments may be applied to multiple different types of communication session servers and embodiments can deal with failures of different types, which may require the location database and failure management node 110 to have additional service-specific knowledge.

Embodiments provide the ability to dynamically cope with failed communication session and can be deployed in ‘cloud’ and virtualized network environments.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments of the present disclosure, which is defined in the accompanying claims.

What is claimed is:

1. A method of processing data in a telecommunications network, the method comprising:
maintaining a list of which communication session servers in a plurality of communication session servers are currently in an active state and which are currently in a failed state, and which communication session servers in the plurality are currently responsible for providing communication services to which subscribers, wherein each communication session server in the plurality is responsible for providing communication services to one or more subscribers;
receiving a query in relation to a communication session involving a given subscriber, the query querying which communication session server in the plurality is currently responsible for providing communication services to the given subscriber;
in response to the list indicating that a first communication session server in the plurality which is currently responsible for providing communication services to the given subscriber currently has an active state, responding to the query with an identifier for the first communication session server; and
in response to the list indicating that the first communication session server in the plurality which is currently responsible for providing communication services to the given subscriber currently has a failed state, conducting a responsibility transfer operation to transfer responsibility for providing communication services to the given subscriber from the first communication session server to a second, different communication session server in the plurality and responding to the query with an identifier for the second communication session server.

2. The method of claim 1, comprising receiving current subscriber responsibility data from one or more communication session servers in the plurality indicating which subscribers a respective communication session server is currently responsible for providing communication services to,
wherein the list is maintained at least in part on the basis of the received current subscriber responsibility data.

3. The method of claim 2, wherein the received current subscriber responsibility data contains at least one indication as to which communication session server in the plurality is a preferred home communication session server for providing communication session services to at least one subscriber.

4. The method of claim 2, wherein the received current subscriber responsibility data contains one or more priority indications as to which communication session servers in the plurality are preferred over other communication session servers in the plurality for providing communication session services to at least subscriber.

5. The method of claim 1, comprising receiving communication session server health data from communication session servers in the plurality indicating which communication session servers in the plurality are currently in an active state,
wherein the list is maintained at least in part on the basis of the received communication session server health data.

6. The method of claim 5, comprising, in response to the received communication session server health data indicating that the first communication session server has returned to an active state, conducting a further responsibility transfer operation to transfer responsibility for providing communication services to the given subscriber from the second communication session server back to the first communication session server.

7. The method of claim 3, wherein the first communication session server comprises a preferred home communication session server for the given subscriber.

8. The method of claim 5, wherein the received communication session server health data is received via a heartbeat mechanism.

9. The method of claim 1, wherein:
at a first point in time, the list indicates that a particular communication session server in the plurality has a failed state,
at a second, subsequent point in time, the list indicates that the particular communication session server has returned to an active state,
during the period between the first point in time and the second point in time:
no query is received in relation to a communication session involving any of the subscribers for which the particular communication session server is responsible for providing communication session services to, and
no responsibility transfer operations are conducted to transfer responsibility for providing communication services to any of the subscribers for which the particular communication session server is responsible for providing communication session services to away from the particular communication session server.

10. The method of claim 1, comprising receiving communication session server available capacity data from communication session servers in the plurality indicating the current available capacity of respective communication session servers in the plurality for providing communication services to subscribers.

11. The method of claim 10, wherein the received communication session server available capacity data indicates that responsibility for one or more additional or one or more fewer subscribers have been provisioned on at least one communication session server in the plurality.

12. The method of claim 10, wherein conducting the responsibility transfer operation comprises selecting the second communication session server from the plurality at least on the basis of the received communication session server available capacity data.

13. The method of claim 1, wherein conducting the responsibility transfer operation comprises preferentially selecting the second communication session server from the plurality in order to balance the processing load for providing communication session services to subscribers between one or more communication session servers in the plurality.

14. The method of claim 1, wherein conducting the responsibility transfer operation comprises preferentially selecting the second communication session server from the plurality on the basis that the query was received from a location associated with the second communication session server.

15. The method of claim 14, wherein the association comprises a proximate geographical location association.

16. The method of claim 1, wherein conducting the responsibility transfer operation comprises preferentially selecting the second communication session server from the plurality on the basis of a hash-based selection.

17. The method of claim 16, wherein an identifier associated with the given subscriber is used as an input to the hash-based selection.

18. The method of claim 1, wherein:
the plurality comprises at least a first group of communication session servers and a second subset of communication session servers, and
conducting the responsibility transfer operation comprises preferentially selecting the second communication session server from the first group instead of the second group.

19. The method of claim 18, wherein the first group is associated with a first geographical location area and the second group is associated with a second, different geographical location area.

20. The method of claim 18, wherein a preferred home communication session server for the given subscriber is comprised within the first group.

21. The method of claim 18, wherein the query was received from a location associated with the first group.

22. The method of claim 1, wherein:
the network comprises a subscriber configuration data node responsible for storing subscriber configuration data for subscribers,
communication services are provided by communication session servers in the plurality to subscribers according to the subscriber configuration data for respective subscribers, and
conducting the responsibility transfer operation comprises instructing the second communication session server to retrieve subscriber configuration data for the given subscriber from the subscriber configuration data node and store the retrieved subscriber configuration data for the given subscriber locally for use in providing communication services to the given subscriber.

23. The method of claim 6, wherein:
the network comprises a subscriber configuration data node responsible for storing subscriber configuration data for subscribers,
communication services are provided by communication session servers in the plurality to subscribers according to the subscriber configuration data for respective subscribers,
conducting the responsibility transfer operation comprises instructing the second communication session server to retrieve subscriber configuration data for the given subscriber from the subscriber configuration data node and store the retrieved subscriber configuration data for the given subscriber locally for use in providing communication services to the given subscriber, and
conducting the further responsibility transfer operation comprises instructing the first communication session server to retrieve subscriber configuration data for the given subscriber from the subscriber configuration data node and store the retrieved subscriber configuration data for the given subscriber locally for use in providing communication services to the given subscriber.

24. The method of claim 6, wherein:
the network comprises a subscriber configuration data node responsible for storing subscriber configuration data for subscribers,
communication services are provided by communication session servers in the plurality to subscribers according to the subscriber configuration data for respective subscribers,
conducting the responsibility transfer operation comprises instructing the second communication session server to retrieve subscriber configuration data for the given subscriber from the subscriber configuration data node and store the retrieved subscriber configuration data for the given subscriber locally for use in providing communication services to the given subscriber, and
conducting the further responsibility transfer operation comprises instructing the second communication session server to delete locally stored subscriber configuration data for the given subscriber.

25. The method of claim 1, comprising, in response to communication service activity via communication session servers in the plurality falling below a predetermined activity threshold, initiating a communication session server deactivation procedure to deactivate one or more communication session servers in the plurality from providing communication services to subscribers.

26. The method of claim 25, wherein initiating the communication session server deactivation procedure comprises conducting one or more responsibility transfer operations to transfer responsibility for providing communication services to subscribers away from the one or more deactivated communication session servers to one or more other communication session servers in the plurality.

27. The method of claim 25, comprising, in response to communication service activity via communication session servers in the plurality rising above the predetermined activity threshold, initiating a communication session server re-activation procedure to re-activate the one or more deactivated communication session servers in the plurality to provide communication services to subscribers.

28. The method of claim 27, wherein initiating the communication session server re-activation procedure comprises conducting one or more responsibility transfer operations to transfer responsibility for providing communication services to subscribers back to the one or more re-activated communication session servers.

29. A non-transitory computer-readable storage medium comprising computer-executable instructions which, when executed by a processor, cause a computing device to perform a method of processing data in a telecommunications network, the method comprising:
maintaining a list of which communication session servers in a plurality of communication session servers are currently in an active state and which are currently in a failed state, and which communication session servers in the plurality are currently responsible for providing communication services to which subscribers, wherein each communication session server in the plurality is responsible for providing communication services to one or more subscribers;
receiving a query in relation to a communication session involving a given subscriber, the query querying which communication session server in the plurality is currently responsible for providing communication services to the given subscriber;
in response to the list indicating that a first communication session server in the plurality which is currently responsible for providing communication services to the given subscriber currently has an active state, responding to the query with an identifier for the first communication session server; and
in response to the list indicating that the first communication session server in the plurality which is currently responsible for providing communication services to the given subscriber currently has a failed state, conducting a responsibility transfer operation to transfer responsibility for providing communication services to the given subscriber from the first communication session server to a second, different communication session server in the plurality and responding to the query with an identifier for the second communication session server.

30. A system for use in processing data in a telecommunications network, the system comprising:
at least one memory including computer program code; and
at least one processor in data communication with the at least one memory, wherein the at least one processor is configured to:
maintain a list of which communication session servers in a plurality of communication session servers are currently in an active state and which are currently in a failed state, and which communication session servers in the plurality are currently responsible for providing communication services to which subscribers, wherein each communication session server in the plurality is responsible for providing communication services to one or more subscribers;
receive a query in relation to a communication session involving a given subscriber, the query querying which communication session server in the plurality is currently responsible for providing communication services to the given subscriber;
in response to the list indicating that a first communication session server in the plurality which is currently responsible for providing communication services to the given subscriber currently has an active state, respond to the query with an identifier for the first communication session server; and
in response to the list indicating that the first communication session server in the plurality which is currently responsible for providing communication services to the given subscriber currently has a failed state, conduct a responsibility transfer operation to transfer responsibility for providing communication services to the given subscriber from the first communication session server to a second, different communication session server in the plurality and respond to the query with an identifier for the second communication session server.
